(19) United States
(12) Patent Application Publication
(10) Pub. No.: US 2009/0309804 A1
(43) Pub. Date: Dec. 17, 2009

(54) Array Antenna for Wireless Communication and Method

(75) Inventors: Zhining Chen, Singapore (SG); Wee Kian Toh, Singapore (SG)

Correspondence Address: VEDDER PRICE P.C., 222 N. LASALLE STREET, CHICAGO, IL, 60601, US

(73) Assignee: Agency for Science, Technology, and Research, Singapore (SG)

(21) Appl. No.: 12/298,490

(22) PCT Filed: Apr. 24, 2007
(86) PCT No.: PCT/SG07/00115

§ 371 Date: Feb. 19, 2009

Related U.S. Application Data
(60) Provisional application No. 60/745,462, filed on Apr. 24, 2006.

(51) Int. Cl. H01Q 21/00

(52) U.S. Cl. 343/893

(57) ABSTRACT

A radiator for wireless communication applications is disclosed. The radiator comprises a first conductor formed along an axis, wherein the first conductor is substantially elongated. The radiator also has a second conductor and a third conductor extending substantially outwardly and centrally from the first conductor. The second conductor and the third conductor are substantially extended from opposite sides of the first conductor and substantially perpendicular to the first conductor The radiator further has a feeding point formed substantially at the centre of the first conductor and at least one radiating element connected to each of the second conductor and the third conductor More specifically, the second conductor, the third conductor and the at least one radiating element connected to each of the second conductor and the third conductor are substantially symmetrical about a plane, the axis being coincident with and extending along the plane.

### CROSS-REFERENCE TO RELATED APPLICATION

This application claims the benefit of U.S. provisional application Ser. No. 60/745,462, filed Apr. 24, 2006 and entitled “Wideband Vertebra Array Antenna” incorporated herein by reference in its entirety.

### FIELD OF INVENTION

The invention relates generally to array antennas. In particular, it relates to an array antenna for wireless communication.

### BACKGROUND

The Wireless Local Area Network (WLAN) has become widely used for outdoor point-to-point wireless communication. Examples of specific standards for implementing WLAN systems are IEEE 802.11b/g/n, or WiFi (Wireless Fidelity), and IEEE 802.16e or, Worldwide Interoperability for Microwave Access (WiMAX), which is used for complimenting the WiFi standard.

As demand for faster rate of data transfer continues to increase, WLAN antennas are required to operate with wider bandwidth and higher frequencies. WLAN antennas are also required to support point-to-point communication with higher operating power. The current operating frequencies of the WLAN, WiFi and WiMAX standards are within the 5 GHz frequency range. More specifically, there are three operating frequency bands, commonly known as tri-band, which are within the 5 GHz frequency range. The frequency ranges of the tri-band are 5.15 to 5.35 GHz, 5.47 to 5.725 GHz and 5.725 to 5.875 GHz.

Conventional array antennas that support high gain point-to-point communication are limited to operate in not more than two of the foregoing three operating frequency bands.

Additionally, a conventional array antenna is usually configured as a multiple-layered metallic structure that consists of multiple radiating elements. Each of the multiple radiating elements is typically connected to two or more substrates, but the use of multiple substrates causes a significant reduction in the gain of the conventional array antennas. As a result, expensive low loss substrates, such as Roger 4003 substrates, are required to ameliorate the reduction in the gain. However, this inevitably increases the complexity and cost of the conventional array antennas.

Furthermore, conventional array antennas have feeding networks that are used to achieve impedance transformation. In order to provide the required impedance transformation, opposite sides of the substrates have soldered striped cables formed thereon. Various non-metallic supports are also necessary for providing structural support to the conventional array antennas. The use of multiple-layered structures which require additional soldering and support to ensure structural integrity undesirably increases the manufacturing cost of conventional array antennas.

There is therefore a need for a wide bandwidth and high gain array antenna that is cost effective for implementation and configured appropriately for providing an efficient point-to-point wireless communication solution.

### SUMMARY

Embodiments of the invention are disclosed hereinafter for providing a cost effective wide bandwidth and high gain array antenna and for providing an efficient point-to-point wireless communication solution.

In accordance with a first embodiment of the invention, there is disclosed a radiator for wireless communication applications. The radiator comprises a first conductor formed along an axis, wherein the first conductor is substantially elongated. The radiator also has a second conductor and a third conductor extending substantially outwardly and centrally from the first conductor. The second conductor and the third conductor are substantially extended from opposite sides of the first conductor and substantially perpendicular to the first conductor. The radiator further has a feeding point formed substantially at the centre of the first conductor and at least one radiating element connected to each of the second conductor and the third conductor. More specifically, the second conductor, the third conductor and the at least one radiating element connected to each of the second conductor and the third conductor are substantially symmetrical about a plane, the axis being coincident with and extending along the plane.

In accordance with another embodiment of the invention, there is disclosed a method for configuring a radiator for wireless communication applications, the method involves providing a first conductor formed along an axis, wherein the first conductor is substantially elongated. The method also involves providing a second conductor and a third conductor extending substantially outwardly and centrally from the first conductor. The second conductor and the third conductor are substantially extended from opposite sides of the first conductor and substantially perpendicular to the first conductor. The method further involves a feeding point being disposed substantially at the centre of the first conductor and at least one radiating element being connected to each of the second conductor and the third conductor. More specifically, the second conductor, the third conductor and the at least one radiating element connected to each of the second conductor and the third conductor are substantially symmetrical about a plane, the axis being coincident with and extending along the plane.

### BRIEF DESCRIPTION OF DRAWINGS

Embodiments of the invention are described in detail hereinafter with reference to the drawings, in which:

FIG. 1 is a plan view of an array antenna having a plurality of radiating elements according to an embodiment of the invention;

FIG. 2 is a side view of the array antenna of FIG. 1;

FIG. 3 is an illustration of geometrical variations of the radiating elements of FIG. 1;

FIG. 4 is a graph showing the simulated and measured return loss characteristics of the array antenna of FIG. 1; and

FIGS. 5a, 5b and 5c are graphs showing radiation patterns of the array antenna of FIG. 1 at 5.1 GHz, 5.4 GHz and 5.8 GHz, respectively.

### DETAILED DESCRIPTION

Embodiments of the invention are described hereinafter with reference to the drawings for addressing the need for a wide bandwidth and high gain array antenna that is cost effective for implementation and configured appropriately for providing an efficient point-to-point wireless communication solution.

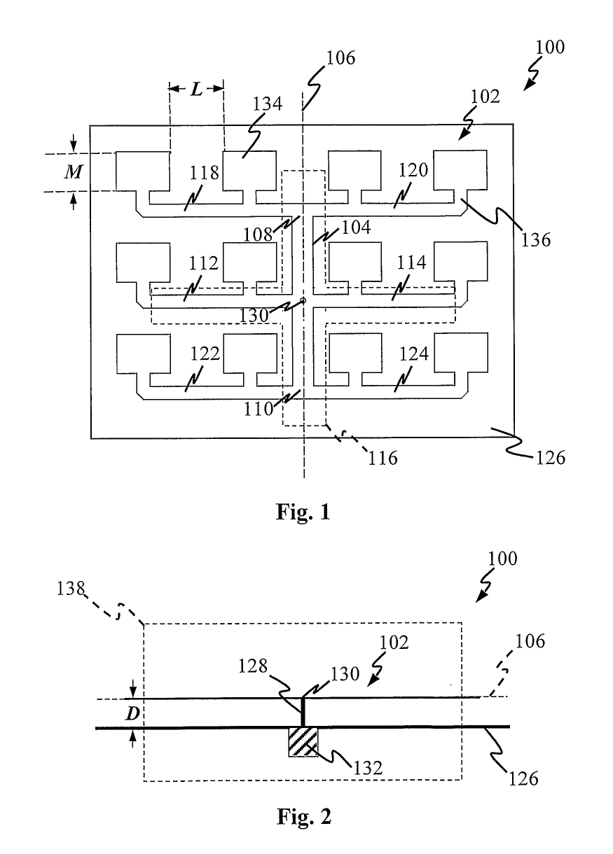

FIG. 1 shows a plan view and the geometry of an array antenna 100 for wide bandwidth and high gain wireless communication applications according to a first embodiment of the invention. The array antenna 100 has a radiator 102 that comprises a first conductor 104 formed along an axis 106 that is coincident with the length of the first conductor 104. The first conductor 104 is preferably an elongated strip and forms a central backbone structure of the radiator 102. The first conductor 104 further has a first end 108 and a second end 110. The width of the first conductor 104 is perpendicular to the axis 106 and is, for example, approximately 6 mm.

The radiator 102 also has a first pair of conductors comprising a second conductor 112 and a third conductor 114. Each of the second conductor 112 and third conductor 114 extends substantially away from a central portion of the first conductor 104. The second conductor 112 and the third conductor 114 are preferably substantially perpendicular to the first conductor 104. The second conductor 112 and the third conductor 114 are preferably collinear and extend from opposite sides of the first conductor 104.

Additionally, the first conductor 104 and the first pair of conductors 112, 114 are preferably coplanar. The arrangement of the first conductor 104 and the first pair of conductors 112, 114 collectively form a vertebra array feed structure 116 of the radiator 102.

The radiator 102 further has a second pair of conductors and a third pair of conductors. The second pair of conductors comprises a fourth conductor 118 and a fifth conductor 120 while the third pair of conductors comprises a sixth conductor 122 and a seventh conductor 124. The second pair 118, 120 and third pair 122, 124 of conductors are preferably coplanar to the vertebra array feed structure 116.

Each of the third and fourth conductors 118, 120 preferably extends substantially outwardly from the first end 108 of the first conductor 104. More specifically, each of the third and fourth conductors 118, 120 is preferably perpendicularly to the first conductor 104 and the axis 106. Additionally, the fourth and fifth conductors 118, 120 are preferably collinear and extend from opposite sides of the first conductor 104.

Similarly, each of the sixth and seventh conductors 122, 124 preferably extends substantially outwardly from the second end 110 of the first conductor 104. More specifically, each of the sixth and seventh conductors 122, 124 is preferably perpendicular to the first conductor 104 and the axis 106. Additionally, the sixth and seventh conductors 122, 124 are preferably collinear and extend from opposite sides of the first conductor 104.

The first pair 112, 114, second pair 118, 120 and third pair 122, 124 of conductors are preferably elongated strips and have the same dimensions. The width of the first pair 112, 114, second pair 118, 120 and third pair 122, 124 of conductors is preferably parallel to the axis 106 and is for example, approximately 4 mm.

FIG. 2 shows a side view along the axis 106 of the array antenna 100 of FIG. 1. The first conductor 104 is preferably displaced from a ground plane 126 via a feed 128. The feed 128 is further connected to a feeding network (not shown) that advantageously does not require any impedance transformation.

The ground plane 126 is preferably parallel to the vertebra array feed structure 116 and is, for example, rectangular in shape. As shown in FIG. 1, an exemplary dimension of the ground plane 126 is approximately 220 mm in length and 180 mm in width and that the length of the ground plane 126 is preferably perpendicular to the axis 106. An exemplary distance D between the ground plane 126 and the vertebra array feed structure 116 is approximately 5 mm.

As shown in FIG. 1, one end of the feed 128 is preferably connected to a feeding point 130 that is formed substantially at the geometrical centre or centroid of the first conductor 104. The other end of the feed 128 is preferably connected through the ground plane 126 to a radio frequency (RF) connector 132. The RF connector 132 is preferably an N-type connector.

One or more radiating elements 134 are preferably connected via connectors 136 to each of the first 112, 114, second 118, 120 and third 122, 124 pairs of conductors. For example, the radiating elements 134 are preferably arranged in a single row along the length of each of the second and third conductors 112, 114. The centre of each radiating elements 134 can be electrically shorted to the ground plane 126 using a metal screw for mechanical stability. The output resistance of the feed 128, which is connected to the feeding point 130, preferably has the same input resistance as the radiating elements 134 for impedance matching. An exemplary value of the input resistance of the radiating elements 134 is 50 Ohm.

With reference to FIG. 1, the radiating elements 134 are preferably plate-like structures and are rectangular in shape. In this first embodiment of the invention, the length of the radiating element 134 is preferably perpendicular to the axis 106. An exemplary dimension of the radiating element 134 is approximately 26 mm in length and 24 mm in width.

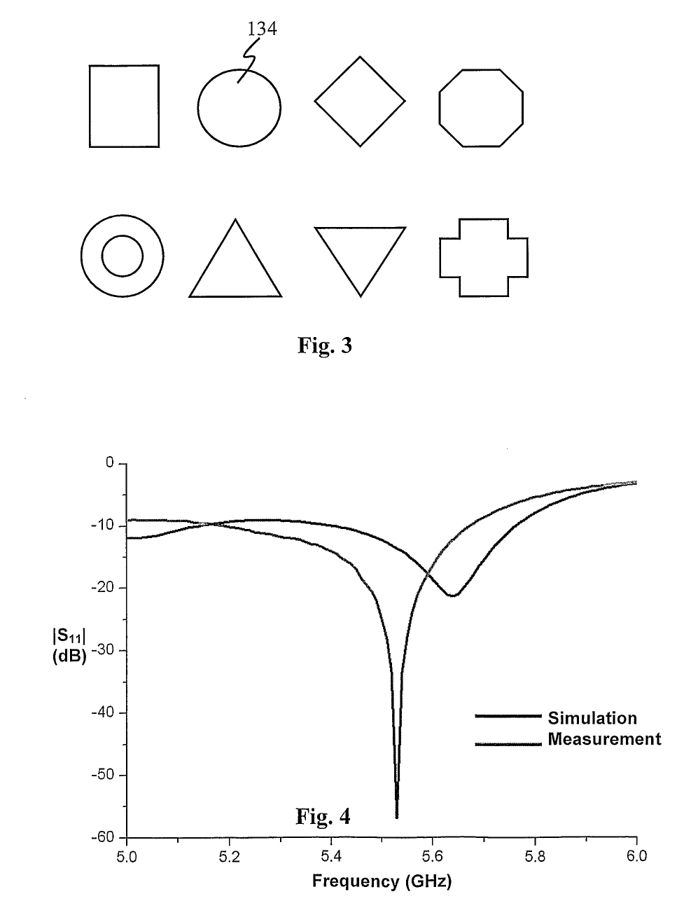

Alternatively, as shown in FIG. 3, the radiating elements 134 can be of any shapes, such as square, triangle, circle, ring, cross and other polygonal shapes. The vertebra array feed structure 116 and the radiating elements 134 connected thereto are preferably unitary and are made of electrically conductive material such as copper.

With reference to FIG. 1, each radiating element 134 is spaced from an adjacent radiating element 134 by an inter-element spacing L. The inter-element spacing L is preferably equal to one half the operational wavelength λ of the array antenna 100. Additionally, each radiating element 134 preferably has a width M that is equal to one half of the operational wavelength λ of the array antenna 100. The width M of each radiating element 134 is parallel to the axis 106.

During operation of the array antenna 100, a current flows through the feeding point 130 via the feed 128. The current subsequently distributes over the vertebra array feed structure 116 and the radiating elements 134. Communication signals are transmitted through and received by the radiating elements 134 with air being the medium for transmission. The distance by which the current flows from one radiating element 134 to an adjacent radiating element 134 is preferably equal to one operational wavelength of the array antenna 100.

The radiator 102 is preferably configured to be symmetrical about a plane 138 containing the axis 106. More specifically, the axis 106 is preferably coincident with and extends along the plane 138. The plane 138 is substantially perpendicular to the first conductor 104. In particular, the first pair, 112, 114, the second pair 118, 120 and third pair 122, 124 of conductors together with the corresponding radiating elements 134 are arranged to be symmetrical about the plane 138. In this way, the radiator 102 is structurally symmetrical about the plane 138.

With reference to the graph of FIG. 4, the array antenna 100 is further capable of achieving high gain over a broad operating bandwidth having a frequency range that is between 5.1 to 5.9 GHz. FIG. 4 shows IE3D simulation and measurement results using a HP8510C Vector Network Analyzer. The results indicate that the array antenna 100 has a desirable return loss S₁₁ performance within the operating bandwidth. The array antenna 102 also has a percentage bandwidth of 14%.

The design of the vertebra array feed structure 116 advantageously facilitates the expansion of the number of radiating elements 134 for obtaining higher gain. This is achieved by increasing the length of the first conductor 104 so that further pairs of conductors are extendable from the first conductor 104 for connecting more radiating elements 134 thereto.

In this first embodiment of the invention, the array antenna 100 preferably has a symmetrical structure with respect to the plane 138. For example, the array antenna 100 preferably has odd pairs of conductors, wherein each pair of conductors preferably has an even number of radiating elements 134 connected thereto.

The array antenna 100 is capable of operating within the frequency range of 5.15 to 5.875 GHz. This means that the array antenna 100 is capable of supporting tri-band operation for each of the WLAN, WiFi and WiMAX standards and thereby advantageously eliminates the need for three separate antennas and the corresponding base band circuitries.

The symmetrical structure of the radiator 102 together with the centralized feeding point 130 allows current flow into the array antenna to achieve symmetrical current distribution about the plane 138. This in turn facilitates the generation of a radiation pattern that is substantially symmetrical in the H-field plane (H-plane). The E-field plane (E-plane) and H-plane are substantially perpendicular to the plane 138.

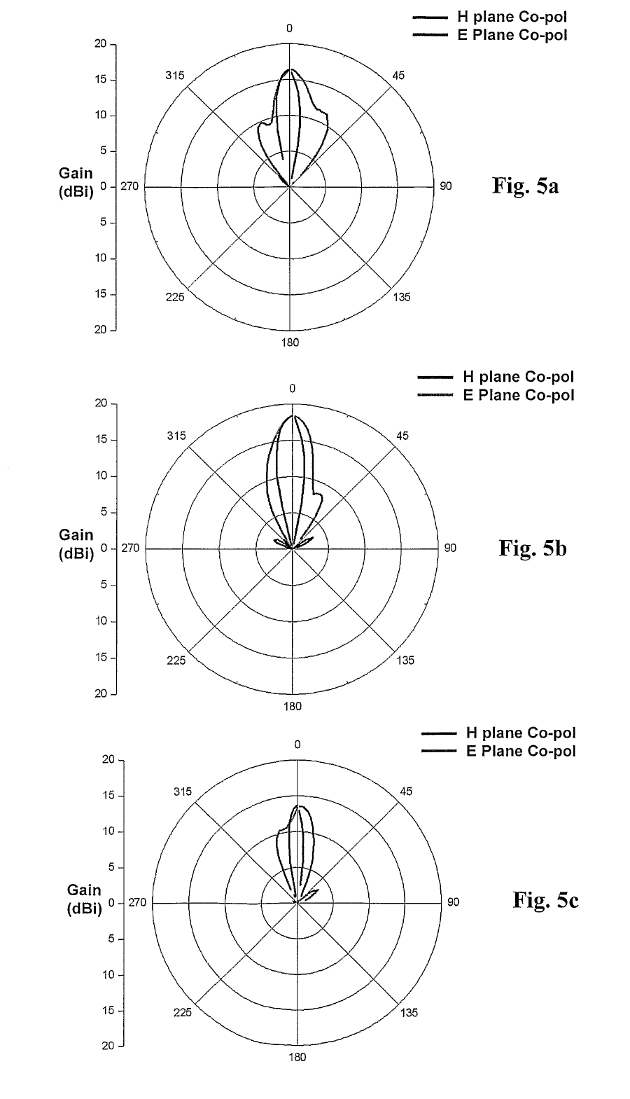

FIGS. 5a to 5c show measured radiating patterns of the array antenna 100 at the following three operating frequencies, 5.1 GHz, 5.4 GHz and 5.8 GHz respectively. Each of FIGS. 5a to 5c also shows a symmetrical radiating pattern in the H-plane that has low side lobes and cross polarization for achieving desirable polarization purity.

In accordance with a second embodiment of the invention, the array antenna 100 further comprises a secondary radiator (not shown) that is arranged in between the radiator 102 and the ground plane 126 for constructing a two-tiered array antenna structure. Portions of the secondary radiator preferably overlap with the radiator 104 so that the secondary radiator is coupled electromagnetically to the radiator 104 during operation of the array antenna 100.

The addition of the secondary radiator also improves the impedance matching performance of the array antenna 100. A further advantage of using the secondary radiator is that the secondary radiator facilitates the generation of second broadband resonances so that the array antenna 100 is able to develop multiple broadband capabilities. The dominant frequency band is dependent on the distance between the radiator 104 and the secondary radiator.

Embodiments of the invention may be advantageously applied to the construction of a high gain array antenna with improved wide bandwidth capabilities and performance. The array antenna is lightweight, low profiled and compact, which results in a reduction in installation space. The array antenna does not have any lump components or folded metal layers, which allows for greater manufacturability. The reduced size of the array antenna further results in lower manufacturing cost and permits widespread deployment.

In the foregoing manner, a cost effective wide bandwidth and high gain array antenna and for providing an efficient point-to-point wireless communication solution is disclosed. Although only a number of embodiments of the invention are disclosed, it becomes apparent to one skilled in the art in view of this disclosure that numerous changes and/or modification can be made without departing from the scope and spirit of the invention.

1. A radiator for wireless communication applications, the radiator comprising:
a first conductor formed along an axis, the first conductor being substantially elongated;
a second conductor and a third conductor extending substantially outwardly and centrally from the first conductor, the second conductor and the third conductor being substantially extended from opposite sides of the first conductor and substantially perpendicular to the first conductor;
a feeding point disposed substantially at the centroid of the first conductor; and
at least one radiating element being connected to each of the second conductor and the third conductor,
wherein the second conductor, the third conductor and the at least one radiating element connected to each of the second conductor and the third conductor are substantially symmetrical about a plane, the axis being coincident with and extending along the plane.

2. The radiator as in claim 1 further comprising:
a ground plane, wherein the first conductor is displaced from the ground plane.

3. The radiator as in claim 2, wherein a feed interconnects the feeding point disposed substantially at the centre of the first conductor and the ground plane.

4. The radiator as in claim 2, wherein the at least one radiating element is connected to the ground plane.

5. The radiator as in claim 3, wherein the feed is further connected to a radio frequency connector.

6. The radiator as in claim 1, wherein the at least one radiating element is displaced from an adjacent radiating element by an operating wavelength of the array antenna.

7. The radiator as in claim 1, wherein the second and third conductors are substantially collinear.

8. The radiator as in claim 1, wherein a second radiating element is disposed adjacent to the at least one radiating element.

9. The radiator as in claim 1, wherein the first conductor, the second conductor, the third conductor and the at least one radiating element are substantially coplanar.

10. The radiator as in claim 1, wherein the first conductor, the second conductor, the third conductor and the at least one radiating element are unitary.

11. A method for configuring a radiator for wireless communication applications, the method comprising the steps of:
providing a first conductor formed along an axis, the first conductor being substantially elongated;
providing a second conductor and a third conductor extending substantially outwardly and centrally from the first conductor, the second conductor and the third conductor being substantially extended from opposite sides of the first conductor and substantially perpendicular to the first conductor;
disposing a feeding point substantially at the centroid of the first conductor; and
providing at least one radiating element being connected to each of the second conductor and the third conductor,
wherein the second conductor, the third conductor and the at least one radiating element connected to each of the second conductor and the third conductor are substantially symmetrical about a plane, the axis being coincident with and extending along the plane.

12. The method as in claim 11, further comprising the step of:
providing a ground plane, wherein the first conductor is displaced from the ground plane.

13. The method as in claim 12, further comprising the step of:
providing a feed for interconnecting the feeding point formed substantially at the centre of the first conductor and the ground plane.

14. The method as in claim 12, wherein the step of providing at least one radiating element being connected to each of the second conductor and the third conductor comprises the step of connecting the at least one radiating element to the ground plane

15. The method as in claim 13, further comprising the step of:
providing a radio frequency connector for connecting to the feed.

16. The method as in claim 11, wherein the step of providing at least one radiating element comprises displacing the at least one radiating element from an adjacent radiating element by an operating wavelength of the antenna array.

17. The method as in claim 11, wherein the step of providing a second conductor and a third conductor comprises the step of forming the second and third conductors substantially collinearly.

18. The method as in claim 11, further comprising the step of:
disposing a second radiating element adjacent to at least one of the at least one radiating element.

19. The method as in claim 11, wherein the first conductor, the second conductor, the third conductor and the at least one radiating element are substantially coplanar.

20. The method as in claim 11, wherein the first conductor, the second conductor, the third conductor and the at least one radiating element are unitary.
